(19) United States
(12) Patent Application Publication
(10) Pub. No.: US 2026/0254894 A1
(43) Pub. Date: Aug. 27, 2026

(54) FLAME FUSION: A SMART, FLAMELESS WICK SYSTEM

(71) Applicant: Keneisha Brown, Ownings Mills, MD (US)

(72) Inventor: Keneisha Brown, Ownings Mills, MD (US)

(21) Appl. No.: 19/062,939

(22) Filed: Feb. 25, 2025

(51) Int. Cl. H04M 1/72412

(52) U.S. Cl. CPC H04M 1/72412

(57) ABSTRACT

A flameless wick device that may comprise a housing and a configurable wireless communication module to connect to a smartphone application. The device may include a flameless wick mechanism configured to produce light without an open flame and a configurable control unit to. One or more sensors may be included, including at least one temperature sensor and at least one orientation sensor. A power source may be configured to provide power to the device components. The flameless wick mechanism may comprise a heating element made of at least one of ceramic, titanium, or tourmaline. An insulation component may surround the heating element to prevent burns. The control unit may be configured to implement at least one safety feature selected from the group consisting of auto shut-off, tip-over protection, and overheat protection. The power source may comprise a rechargeable battery and a charging pad integrated into the base of the device.

### FIELD OF THE INVENTION

The present disclosure relates generally to candle alternatives and, more particularly, to a smart, flameless wick system that provides a safe and eco-friendly alternative to traditional candles.

### BACKGROUND

Traditional candles have been used for centuries to provide light, ambiance, and fragrance. However, candles with open flames pose significant safety risks, particularly in residential settings. According to National Fire Protection Association (NFPA) reports from 2018-2022, candles were responsible for 4% of home fires, 3% of home fire deaths, 6% of home fire injuries, and 4% of direct property damage in home fires, resulting in $257 million in property damage.

Various alternatives to traditional candles have been developed, including electric candles and wax warmers. However, these alternatives often lack the aesthetic appeal and functionality of traditional candles. There remains a need for a safe and eco-friendly alternative that maintains the desirable aspects of traditional candles while eliminating the associated fire risks. The present disclosure is directed to addressing one or more of the issues set forth above and/or other issues in the prior art.

### BRIEF OVERVIEW

In one aspect, a flameless wick device may include a housing, a flameless wick mechanism, a control unit, one or more sensors, a wireless communication module, and a power source. The flameless wick mechanism may be configured to produce light without an open flame. The control unit may be configured to manage device functions. The one or more sensors may include at least one temperature sensor and at least one orientation sensor. The wireless communication module may be configured to connect to a smartphone application. The power source may be configured to provide power to the device components.

In another aspect, a method of operating a flameless wick device may include powering on the device, establishing a connection with a smartphone application, activating a flameless wick mechanism to produce light, monitoring temperature and orientation of the device, and executing commands received from the smartphone application. In yet another aspect, a system for providing a safe alternative to traditional candles may include one or more flameless wick devices and a smartphone application. The smartphone application may be configured to control the one or more flameless wick devices, including setting operating parameters, creating preset programs, and monitoring device status.

### BRIEF DESCRIPTION OF THE DRAWINGS

FIG. 1 is a schematic diagram illustrating an exemplary flameless wick device, in accordance with embodiments of the present disclosure.

FIG. 2 is a schematic diagram illustrating an exemplary insulation component of a flameless wick device, in accordance with embodiments of the present disclosure.

FIG. 3 is a schematic diagram illustrating an exemplary heating element of a flameless wick device, in accordance with embodiments of the present disclosure.

FIG. 4 is a schematic diagram illustrating exemplary components of a flameless wick device, in accordance with embodiments of the present disclosure.

FIG. 5 is a schematic diagram illustrating an exemplary flameless wick device with a charging pad and communication components, in accordance with embodiments of the present disclosure.

FIG. 6A is a schematic diagram illustrating exemplary internal components of a flameless wick device, in accordance with embodiments of the present disclosure.

FIG. 6B is a schematic diagram illustrating exemplary internal components of a flameless wick device, in accordance with embodiments of the present disclosure.

FIG. 7 is a schematic diagram illustrating exemplary components of a computing system that may be used in a flameless wick device, in accordance with embodiments of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, instances of the word "exemplary" are used to indicate an example, instance, or illustration, and any embodiment described as "exemplary" is not to be construed as preferred or advantageous over other embodiments. Further, although exemplary embodiments are described herein, the scope of the disclosure is not limited to the specific embodiments described.

The present disclosure describes various embodiments of a flameless wick device, system, and method, collectively referred to as "Flame Fusion." The Flame Fusion device may provide a safe and eco-friendly alternative to traditional candles, eliminating the risks associated with open flames while maintaining the aesthetic appeal and functionality of candles. The flameless wick device may comprise a housing that may be configured to resemble a traditional candle holder. The housing may be designed to accommodate standard candle jar glass thickness, allowing for compatibility with various existing candle containers. The flameless wick mechanism may include a heating element that may be configured to produce heat without an open flame. The heating element may be made of at least one of ceramic, titanium, or tourmaline. The heating element may be designed as a flat, plate-like structure that may be integrated with a resistive wire for heat generation.

An insulation component may surround the heating element to prevent burns from direct contact. The insulation may help ensure safe operation of the device by minimizing the risk of accidental burns to users. The control unit of the flameless wick device may be configured to manage various device functions. The control unit may include a thermostat that may regulate the heat generated by the heating element. The thermostat may be designed to maintain a temperature range between approximately 130°F and 190°F.

The flameless wick device may include one or more sensors, including at least one temperature sensor and at least one orientation sensor. The temperature sensor may work in conjunction with the thermostat to monitor and maintain the desired operating temperature. The orientation sensor may be used to detect if the device has been tipped over, enabling the implementation of safety features.

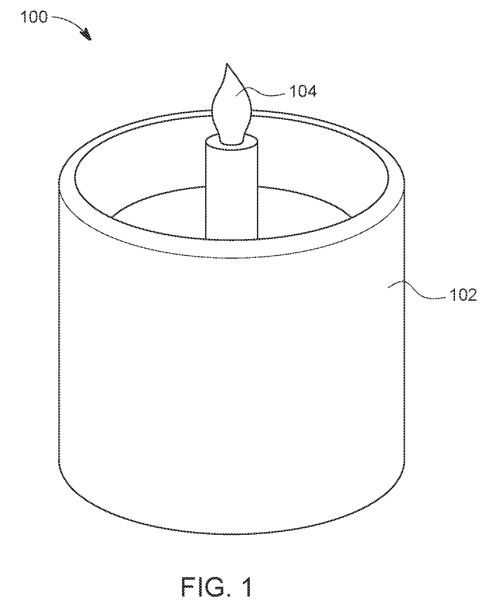

FIG. 1 illustrates an exemplary flameless wick device 100, in accordance with embodiments of the present disclosure. The device 100 may include a housing 102 designed to resemble a traditional candle or decorative object. The housing 102 may be compatible with standard candle jar glass thickness. A flameless wick mechanism 104 may be positioned at the top of the housing 102, similar to a traditional candle wick. The flameless wick mechanism 104 may be configured to produce light without an open flame, potentially using LED or other light-emitting technology. The flameless wick device 100 may include various components to provide its functionality and safety features. These components may include, but are not limited to, a control unit, one or more sensors, a wireless communication module, and a power source.

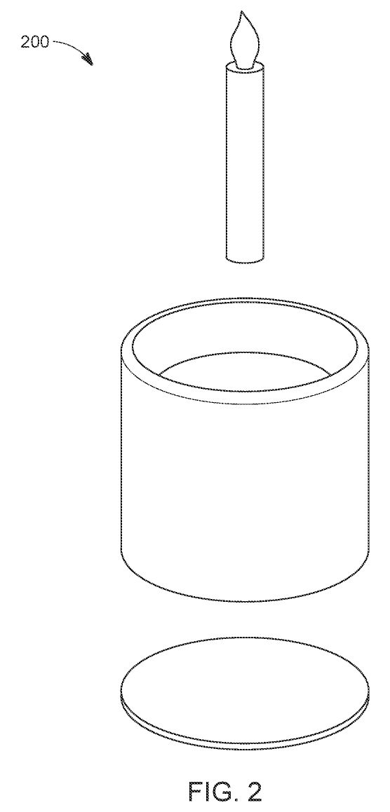

FIG. 2 illustrates an exemplary insulation component 200 of a flameless wick device, in accordance with embodiments of the present disclosure. The insulation component 200 may be present to prevent burns from direct contact with the heating element. The insulation may surround the heating element, as indicated by the green boundary in the figure.

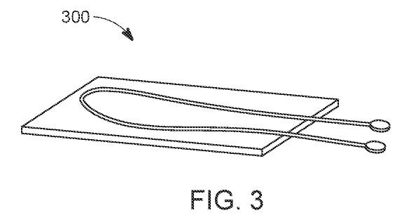

FIG. 3 illustrates an exemplary heating element 300 of a flameless wick device, in accordance with embodiments of the present disclosure. The heating element 300 may include a resistive wire that is integrated into plates to generate heat when electricity flows through it. The heating element 300 may be made of materials such as ceramic, titanium, or tourmaline. The flameless wick device may include a temperature-controlled system to regulate heat, ensuring it reaches the desired level without overheating. The temperature range may be approximately 130-190°F, with a preset temperature of about 145°F. When powered on, electricity may flow through the heating element, causing the wick to heat up. The incoming heat from the heating plate (wick) may melt the wax and release the aroma from oils.

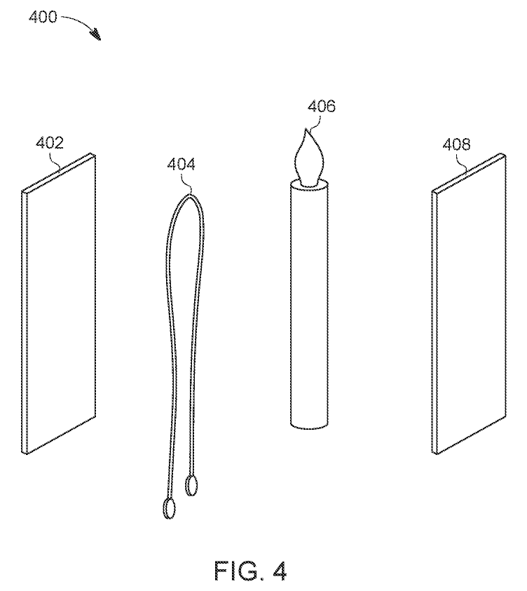

FIG. 4 illustrates exemplary components of a flameless wick device, in accordance with embodiments of the present disclosure. The components may include a standing rectangular heat conductive component 402, a heating element component 404, a light source 406 (which may resemble a flame), and another rectangular heat conductive component 408. These components may be assembled to form the flameless wick mechanism.

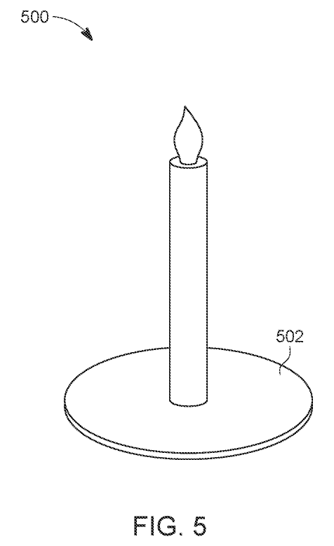

FIG. 5 illustrates an exemplary flameless wick device 500 with a charging pad and communication components, in accordance with embodiments of the present disclosure. The device 500 may include a circular base 502 that serves as a charging pad and may also include Bluetooth or other wireless communication technology for app communication.

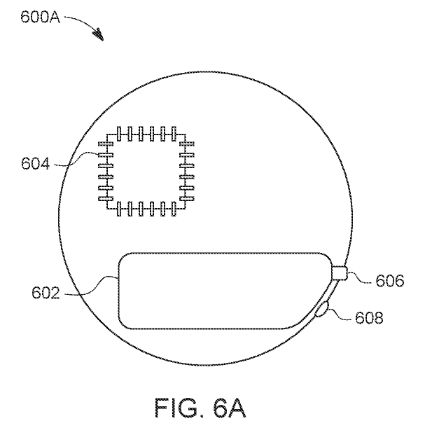

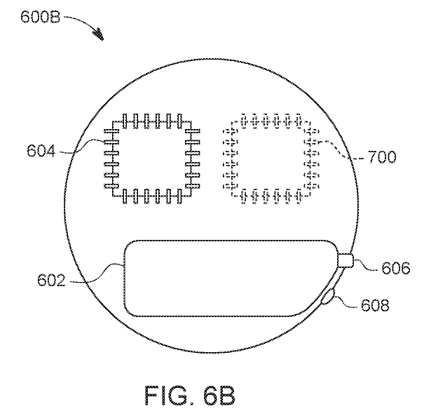

FIG. 6A illustrates exemplary internal components of a flameless wick device, in accordance with embodiments of the present disclosure. The device may include a battery 602, which may be rechargeable. A Bluetooth or Wi-Fi module 604 may be included for wireless communication. The device may also include a charging port 606 and a power button 608. In one or more embodiments, the flamless wick device may comprise an application programming interface (API) which allows the various modules of the device to communicate, interact, and work together.

FIG. 6B illustrates the flameless wick device further comprising a central processing unit (CPU) 700 configured to control and coordinate the various components and functions of the device. As shown in FIG. 6B, the CPU 700 may be integrated within the circular disk 600B that houses other key components such as the wireless communication module 604, battery 602, recharging port 606, and power button 608.

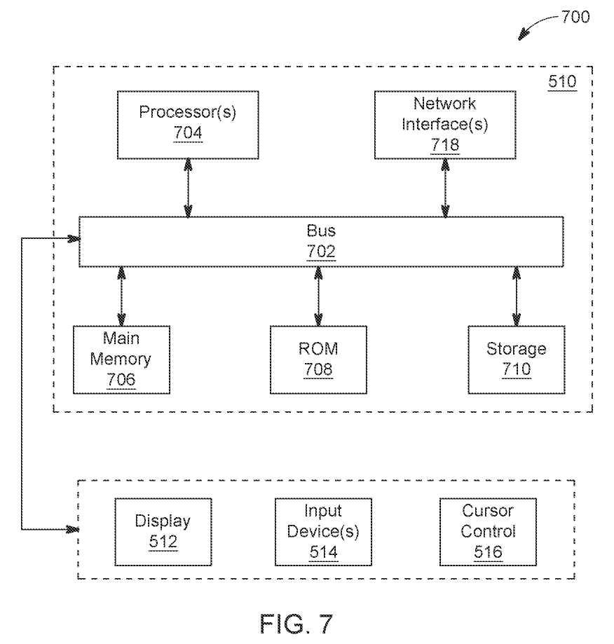

FIG. 7 may depict a schematic diagram of a control system 700 for the flameless wick device, in accordance with embodiments of the present disclosure. The control system 700 may be enclosed within a housing 510 and may include a bus 702 that connects various components. These components may include one or more processors 704, a main memory 706, a read-only memory (ROM) 708, and a storage device 710. The control system 700 may also include a network interface 718 for wireless communication. Additional components may include a display 512, one or more input devices 514, and a cursor control 516. These components may work together to manage the functions of the flameless wick device, including temperature control, wireless communication, and user interface operations.

The CPU 700 may be implemented as a microcontroller or microprocessor capable of executing instructions to manage the device operations. FIG. 7 illustrates a more detailed schematic diagram of the CPU 700 and associated components. The CPU 700 may include one or more processors 704 connected to a bus 702. The bus 702 may serve as an interconnect between the processor(s) 704 and other components such as main memory 706, read-only memory (ROM) 708, and storage 710. The CPU 700 may comprise manage an application programming interface (API) which allows the various modules of the device to communicate, interact, and work together.

The main memory 706 may comprise random access memory (RAM) or other dynamic storage devices for storing information and instructions to be executed by the processor(s) 704. The ROM 708 may store static information and instructions for the processor(s) 704. The storage 710 may include a magnetic disk, optical disk, solid-state drive, or other storage devices for storing data and instructions.

The CPU 700 may also include one or more network interfaces 718 for communicating with external devices or networks, such as the wireless communication module 604 shown in FIG. 6B. This may enable connectivity with a smartphone application for remote control and monitoring of the flameless wick device.

Additional components that may be connected to the CPU 700 include a display 512, input device(s) 514, and cursor control 516. These components may be part of a user interface on the flameless wick device itself, allowing for local control and status indication.

The CPU 700 may execute instructions stored in memory to control various aspects of the flameless wick device operation, including:
Managing power delivery to the heating element
Regulating temperature based on sensor readings
Processing inputs from the power button and/or smartphone application
Controlling the light source for flame simulation
Implementing safety features such as auto-shutoff and tip-over protection
Facilitating wireless communication for remote control and monitoring

By integrating a CPU with the capabilities shown in FIG. 7, the flameless wick device may provide sophisticated control, safety features, and user interaction possibilities beyond what a simple heating element alone could offer. This may enable a more realistic and customizable candle-like experience while maintaining the safety advantages of a flameless design.

The flameless wick mechanism may include a light source configured to produce light without an open flame. The light source may comprise one or more LED lights. The LED lights may be arranged to simulate the appearance of a flickering candle flame. The control unit may be configured to adjust the intensity and/or color of the light produced by the light source. This may allow customization of the lighting effects to suit different user preferences or environments.

The flameless wick mechanism may further include a fragrance diffuser component. The fragrance diffuser may be configured to release scented oils or other aromatic substances when heated by the heating element. This may allow the device to produce pleasing fragrances similar to scented candles. The housing of the device may be designed to resemble traditional candle holders or jars. The housing may be made of heat-resistant materials such as glass, ceramic, or metal. The housing may include decorative elements to enhance the aesthetic appeal of the device.

The smartphone application may include features for scheduling device operation. Users may be able to set timers for the device to turn on and off automatically at specified times. The app may also allow creation of custom lighting programs, such as gradually dimming over time to simulate a real candle burning down. The device may include multiple temperature sensors positioned at different locations. This may allow for more precise temperature monitoring and control. The control unit may use input from the multiple sensors to ensure even heating and prevent localized hot spots. The orientation sensor may comprise an accelerometer or gyroscope. The sensor may detect changes in device orientation in multiple axes. This may allow the tip-over protection feature to activate if the device is tilted beyond a certain threshold angle in any direction.

The flameless wick device may include several safety features, such as auto shut-off, tip-over protection, and overheat protection. These features may be implemented through the control unit and various sensors included in the device. The flameless wick system may also include smart features that can be accessed through a smartphone application. These features may include, but are not limited to: Turning on/off single or multiple devices; Setting timers; Setting temperature; Creating preset programs; Monitoring device status; Receiving notifications for device status or safety alerts. The wireless communication module may allow the device to connect to a home automation system. This may enable integration with other smart home devices and allow for centralized control of multiple flameless wick devices throughout a home or building.

The smartphone application may allow users to control multiple Flame Fusion devices simultaneously, if applicable. The application may also provide a user interface for setting desired parameters such as light intensity, duration, and temperature. In some embodiments, the flameless wick device may be powered through a circular disk that is secured to the bottom of a wax jar. The disk may contain the battery, wireless communication module, charging port, and power button. The flameless wick device may be designed to work with separate wax kits, allowing users to change scents as desired. The device may be compatible with various types of wax and fragrance oils.

The method of operating the flameless wick device may include the following steps:
1. Placing the Flame Fusion device in a desired location
2. Powering on the device
3. Opening the smartphone app and connecting to the device
4. Setting desired parameters (e.g., light intensity, duration, temperature)
5. Creating preset programs for automated operation
6. Monitoring device status through the app
7. Controlling multiple Flame Fusion devices simultaneously (if applicable)
8. Receiving notifications for device status or safety alerts
9. Powering off the device manually or relying on the auto shut-off feature

As such, the method of operating the flameless wick device follow a flow wherein to operate the Flame Fusion device, the user begins by placing the device in a desired location. Once positioned, the device is powered on either manually or through the smartphone app. The user then opens the FlameFusion app on their smartphone and establishes a connection with the device. Through the app interface, the user can set desired parameters such as light intensity, duration, and temperature. The app also allows for the creation of preset programs for automated operation, providing convenience and customization options.

As the device operates, the user can monitor its status through the app, receiving real-time information on temperature, battery life, and other relevant metrics. For users with multiple Flame Fusion devices, the app enables simultaneous control of all connected units, allowing for coordinated ambiance across different areas. The app also provides notifications for device status updates or safety alerts, keeping the user informed of any potential issues.

When the user wishes to turn off the device, they can do so manually or rely on the auto shut-off feature, which can be programmed through the app. This auto shut-off functionality adds an extra layer of safety, ensuring the device powers down after a predetermined period or in case of any detected anomalies. Throughout the operation, the device's built-in safety features, including tip-over protection and overheat protection, work continuously to prevent accidents and provide peace of mind to the user.

The Flame Fusion system may provide several advantages over traditional candles, including but not limited to: eliminating open flames and associated fire risks; Transforming manual candle operation to a smart, connected experience; Converting single-use candles to a reusable, sustainable alternative; Improving the atmosphere through greenhouse gas emissions control; Shifting from limited control to precise, programmable settings; Changing from localized operation to remote control capability; Evolving from passive fire risk to active safety monitoring and protection; Transitioning from discrete candle use to an integrated smart home experience.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS . A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicate with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local networks and Internet both use electrical, electromagnetic or optical signals that carry digital data streams. The signals through the various networks and the signals on network link and through communication interface 718, which carry the digital data to and from computer system 710, are example forms of transmission media.

The computer system 700 can send messages and receive data, including program code, through the network(s), network link and communication interface 718. In the Internet example, a server might transmit a requested code for an application program through the Internet, the ISP, the local network and the communication interface718.

The received code may be executed by processor 704 as it is received, and/or stored in storage device 510, or other non-volatile storage for later execution. In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure. Insofar as the description above and the accompanying drawing disclose any additional subject matter that is not within the scope of the claims below, the disclosures are not dedicated to the public and the right to file one or more applications to claims such additional disclosures is reserved.

What is claimed is:

1. A flameless wick device comprising:
a housing;
a flameless wick mechanism configured to produce light without an open flame;
a control unit configured to manage device functions;
one or more sensors, including at least one temperature sensor and at least one orientation sensor;
a wireless communication module configured to connect to a smartphone application; and
a power source configured to provide power to the device components.

2. The flameless wick device of claim 1, wherein the flameless wick mechanism comprises a heating element made of at least one of ceramic, titanium, or tourmaline.

3. The flameless wick device of claim 2, further comprising an insulation component surrounding the heating element to prevent burns from direct contact.

4. The flameless wick device of claim 1, wherein the control unit is configured to implement at least one safety feature selected from the group consisting of auto shut-off, tip-over protection, and overheat protection.

5. The flameless wick device of claim 1, wherein the wireless communication module comprises at least one of a Bluetooth module, a Wi-Fi module, and an API module.

6. The flameless wick device of claim 1, wherein the power source comprises a rechargeable battery.

7. The flameless wick device of claim 1, further comprising a charging pad integrated into a base of the device.

8. A method of operating a flameless wick device, the method comprising:
powering on the flameless wick device;
establishing a connection with a smartphone application;
activating a flameless wick mechanism to produce light;
monitoring temperature and orientation of the device;
executing commands received from the smartphone application; and
implementing at least one safety feature based on the monitored temperature and orientation.

9. The method of claim 8, further comprising:
receiving, via the smartphone application, at least one operating parameter selected from the group consisting of light intensity, duration, and temperature; and
adjusting operation of the flameless wick device based on the received operating parameter.

10. The method of claim 8, wherein implementing the at least one safety feature comprises at least one of:
activating an auto shut-off feature after a predetermined time;
activating a tip-over protection feature when a change in orientation is detected; or
activating an overheat protection feature when a temperature exceeds a predetermined threshold.

11. The method of claim 8, further comprising creating a preset program for automated operation of the flameless wick device.

12. The method of claim 8, further comprising controlling multiple flameless wick devices simultaneously via the smartphone application.

13. The method of claim 8, further comprising sending a notification to the smartphone application regarding at least one of device status or a safety alert.

14. A system for providing a safe alternative to traditional candles, the system comprising:
one or more flameless wick devices, each device comprising:
a housing;
a flameless wick mechanism configured to produce light without an open flame;
a control unit configured to manage device functions;
one or more sensors, including at least one temperature sensor, one auto shut off, and at least one orientation sensor;
a wireless communication module; and
a power source; and
a smartphone application configured to:
connect to the one or more flameless wick devices via the wireless communication module;
control operation of the one or more flameless wick devices;
receive status information from the one or more flameless wick devices; and
display the status information to a user.

15. The system of claim 14, wherein the smartphone application is further configured to:
set operating parameters for the one or more flameless wick devices;
create preset programs for automated operation of the one or more flameless wick devices; and
monitor safety features of the one or more flameless wick devices.

16. The system of claim 14, wherein each flameless wick device further comprises a heating element configured to melt wax and release fragrance.

17. The system of claim 16, wherein the heating element is made of at least one of ceramic, titanium, or tourmaline.

18. The system of claim 14, wherein the control unit of each flameless wick device is configured to implement at least one safety feature selected from the group consisting of auto shut-off, tip-over protection, and overheat protection.

19. The system of claim 14, wherein the power source of each flameless wick device comprises a rechargeable battery, and wherein each flameless wick device further comprises a charging pad integrated into a base of the device.

20. The system of claim 14, wherein the smartphone application is further configured to:
control multiple flameless wick devices simultaneously;
set different operating parameters for each of the multiple flameless wick devices; and
receive and display individual status information for each of the multiple flameless wick devices.
